(19) United States
(12) Patent Application Publication
(10) Pub. No.: US 2002/0188638 A1
(43) Pub. Date: Dec. 12, 2002

(54) Document negotiation

(76) Inventor: Walter Hamscher, Concord, MA (US)

Correspondence Address: DAVID L. FEIGENBAUM, Fish & Richardson P.C., 225 Franklin Street, Boston, MA, 02110-2804, US

(21) Appl. No.: 09/877,694

(22) Filed: Jun. 8, 2001

(51) Int. Cl. G06F 17/24; G06F 17/00

(52) U.S. Cl. 707/530; 707/500

(57) ABSTRACT

Capturing and storing the process of negotiating an agreement between individuals at different enterprises is done using computers and various communication network protocols.

### BACKGROUND

This invention relates to document negotiation.

People and organizations having a mixture of mutual and opposing interests may wish to negotiate an agreement, such as a commercial transaction, that includes mutual obligations. Typically, the agreement is captured in written form. In many cases, such as in a master agreement covering future commercial transactions between enterprises, there may be many factors that interact to produce a complex situation in which it is difficult for individuals involved in the negotiation to arrive efficiently at a mutually beneficial agreement.

These complexities may include: ensuring the involvement and commitment of all involved individuals; facilitating visibility into the progress of the negotiation, particularly for individuals with responsibility for several concurrent negotiations; prioritizing a party's own interests and making assessments of risks and rewards; identifying feasible options with the other party without making premature commitment; simultaneously considering mutually exclusive alternatives; finding and making use of supporting information and prior experience, such as provisions needed to cover contingencies for external events or failure to perform; communicating information within one's organization while maintaining confidentiality; defining commitments to monitoring future performance, particularly where monitoring is done by computer systems.

The complexities are even greater in cases in which the organizations seeking the agreement are distributed geographically, with individuals participating from different time zones, and the value, nature and possibility of the agreement is affected by the passage of time and external events. The negotiation process may become costly and time consuming, with loss of information, difficulty in tracking status, inability to make incremental progress on portions of an agreement, breaches of confidentiality and changes of participants.

Computer systems and networks that provide the participants in a negotiation process with word processors, databases, electronic mail and web sites, are often used to convey proposed written texts of an agreement among the participants.

General-purpose word processing software is routinely used to author and edit negotiated agreements. Microsoft Word, for example, provides mechanisms to (a) protect an entire document with separate passwords for reading and writing, (b) create a document consisting of several separate files, each with its own password protection, (c) maintain a single file that contains a number of successive versions of the document, (d) track and highlight changes made by different users through “redlining”, (e) allow a user to create a form that is protected from editing except for specific document sections, short text fields, radio buttons, and drop-down lists that other users are allowed to edit, and write scripts for actions that can be executed when certain form fields are changed or when other events such as opening or saving a file occur.

General-purpose groupware is routinely used to manage shared databases of text and other documents. Lotus Notes, for example, provides mechanisms to (a) create forms that, when their fields are filled in, can be saved as documents that can be protected via public-key encryption at either the entire document level or at the level of individual fields, (b) create documents portions of which can contain text and other data that is computed from the values of the fields in the form, (c) maintain an ACL (Access Control List) and apply the ACL to entire documents or individual sections and fields, (d) script a workflow in which changes to a document trigger notifications to individual users or group aliases, (e) maintain a series of versions of a document as a list of separate “response” documents, (f) attach a separate document (e.g., a Microsoft Word document) to a Notes document, and (g) allow the content of the fields of the document to be extracted via database queries.

Document generation tools are commonly used for routine legal documents such as wills and pleadings. These applications, such as Corel WordPerfect Legal Office, provide mechanisms to (a) guide a user through a series of yes/no, multiple-choice questions and form-filling steps, which then run scripts to select from a library of terms and conditions, (b) generate a draft word processing document that complies with legal or branding requirements, and (c) allow the sophisticated user to create and save template documents.

Various forms of joint optimization exist and have been used to automate negotiation. In this approach, such as that used in SmartSettle, (a) the opposing parties enumerate possible options as a model consisting of a set of discrete or continuous variables, (b) parties express their preferences and objectives with respect to the bindings of those variables, and (c) algorithms analyze these preferences and find preferred solutions that can be presented to the users for acceptance, rejection or further modification.

### SUMMARY

In general, in one aspect, the invention features a method that includes enabling enabling a party to a negotiation to create a document containing text, typed data, and formulas configured to generate optional texts, enabling a party to the negotiation to manipulate the document as a hierarchically structured set of containers, and permitting a party to view protected portions of the document only upon presentation of a cipher key associated with those portions.

In general, in another aspect, the invention features a method that includes enabling a party to a negotiation to create a document containing text, typed data, and formulas configured to generate optional texts, enabling a party to the negotiation to manipulate the document as a hierarchically structured set of containers, and maintaining a version history of portions of the document sufficient to enable a user to view and display changes between successive versions of the document.

In general, in another aspect, the invention features a method that includes enabling a party to a negotiation to create a document containing text, typed data, and formulas configured to generate optional texts, enabling a party to the negotiation to add annotations to the document, and maintaining a version history of portions of the document sufficient to enable a user to view and display changes between successive versions of the document.

In general, in another aspect, the invention features a method that includes enabling a party to a negotiation to create a document containing text, typed data, and formulas configured to generate optional texts, enabling a party to the negotiation to manipulate the document as a hierarchically structured set of containers, permitting a party to view protected portions of the document only upon presentation of a cipher key associated with those portions, and maintaining a version history of portions of the document sufficient to enable a user to view and display changes between successive versions of the document.

In general, in another aspect, the invention features a method that includes enabling a party to the negotiation to create a document containing text, typed data, and formulas configured to generate optional texts, enabling a party to the negotiation to manipulate the document as a hierarchically structured set of containers, enabling a party to a negotiation to add annotations to the document, permitting a party to view protected portions of the document only upon presentation of a cipher key associated with those portions, and maintaining a version history of portions of the document sufficient to enable a user to view and display changes between successive versions of the document.

Implementations of the invention may include one or more of the following features. A state and history of the negotiation is transmitted from user to user using a network communication protocol. The protocol includes e-mail, client-server file transfer, or peer-to-peer file transfer.

In general, in another aspect, the invention features apparatus including a medium on which are stored data structures capable of configuring a machine to enable a negotiation of a document. The data structures include linked discrete elements, each of the linked elements having value binding and formula features. Each of the elements is linked into a hierarchical structure. Each of the linked elements has annotation features. The data structures are expressed in a serialized data format that represents content of the linked discrete elements encrypted separately for each group of users able to access parts of the document. The content of linked discrete elements are associated with a version history capable of configuring a machine to render complete document versions. The medium also stores software capable of configuring the machine to enable a user to create the document, edit the document by adding new versions, attach messages, add, remove and change the access rights of users with respect to individual document elements, compare and merge documents, and purge version histories.

Other features and advantages of the invention will be apparent from the description and drawings, and from the claims.

### DESCRIPTION

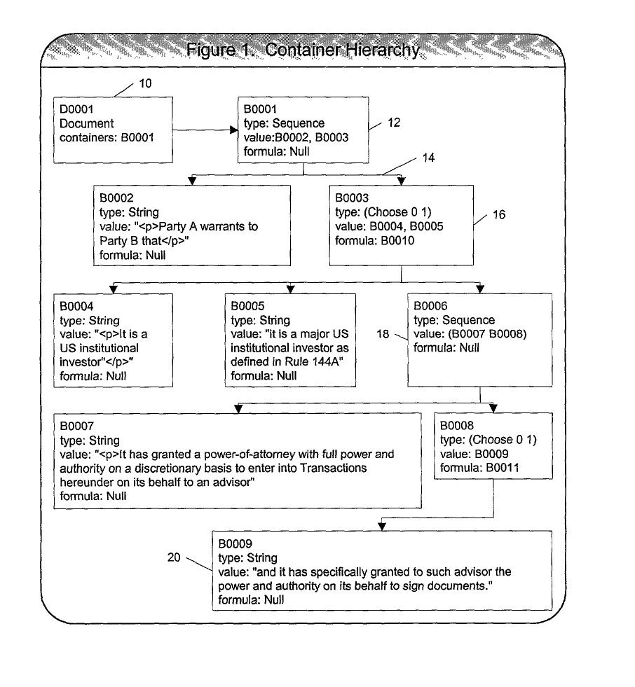

FIGS. 1 through 5 are block diagrams.

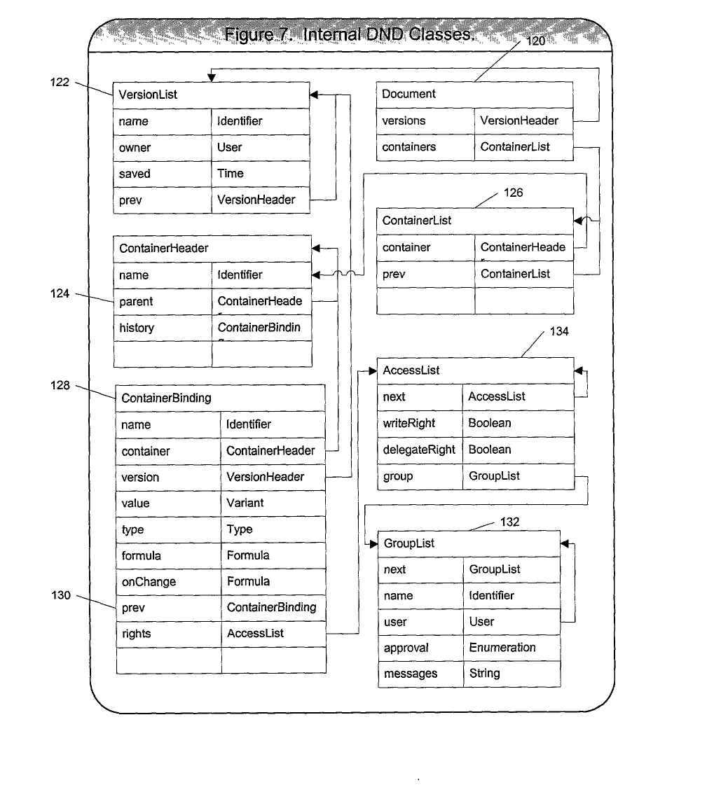

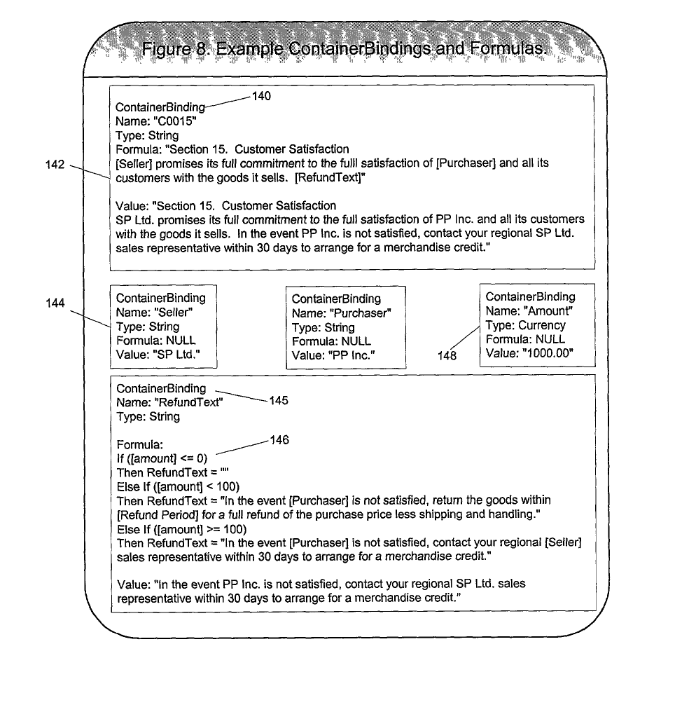

FIGS. 6 and 7 show data structures.

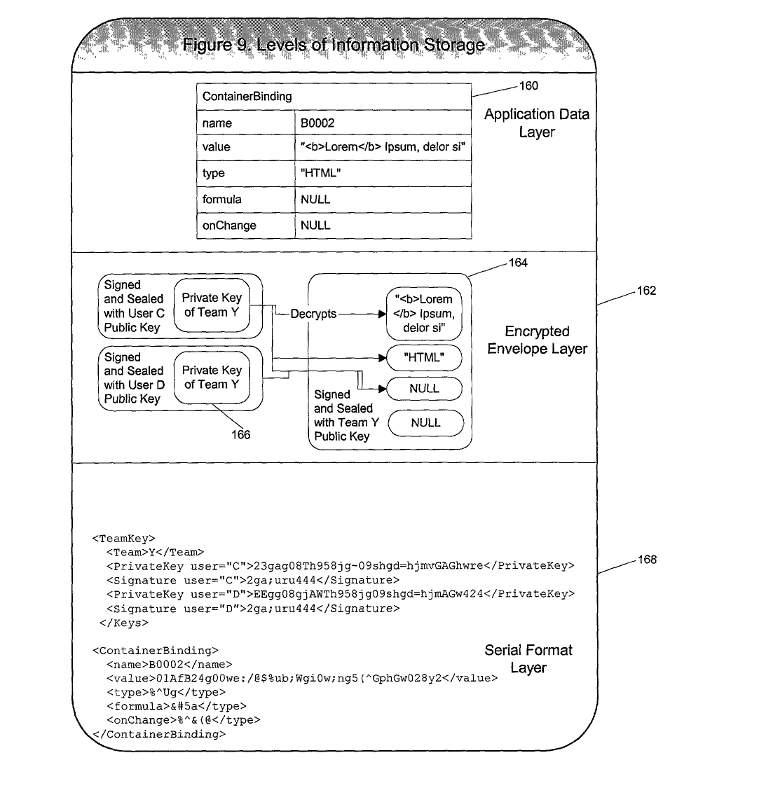

FIG. 8 shows an example container.

FIG. 9 shows information storage layers.

For purposes of document negotiation, each of the parties may invoke a user interface to create, modify, and share with other participants an electronic document that represents the current state of a negotiated agreement. This electronic document may be called a Dynamic Negotiation Document (DND).

The current state of the negotiated agreement may include:

the currently proposed text of the agreement;

alternative elements such as words, clauses, sections, or any other structural element of the text;

data elements such as prices, units of measure, quantities, dates, and catalog identifiers;

permissions of individuals to view, modify, or delegate permissions to others with respect to those elements;

formulae that express dependencies between the elements of the agreement;

a history of changes to the elements sufficient to reconstruct intermediate states of the negotiation and to identify the users responsible for changes in each version;

approval or rejection of individual elements by participants empowered to approve or reject those elements; and

rules governing actions that a software application must take in response to changes to the elements, such as recalculations, notifications to individual participants, or special presentations such as highlighting or italicization.

For this purpose, as shown in FIG. 1 the document 10 contains a set of distinct “container” elements 12. The container elements 12 are arranged into an ordered, directed graph 14 without any cycles so as to form a strict hierarchy. The current contents of the container elements, when traversed and displayed in order, represent the text of the current document version. Container elements may have values of different types, including but not limited to a Sequence type 12 all of whose children are traversed, a Choice type 16 for which only some subset of the children are traversed based on the value of a formula, or other standard data types such as String 20. Container elements may be nested, with Sequences inside Choices 18 and vice versa.

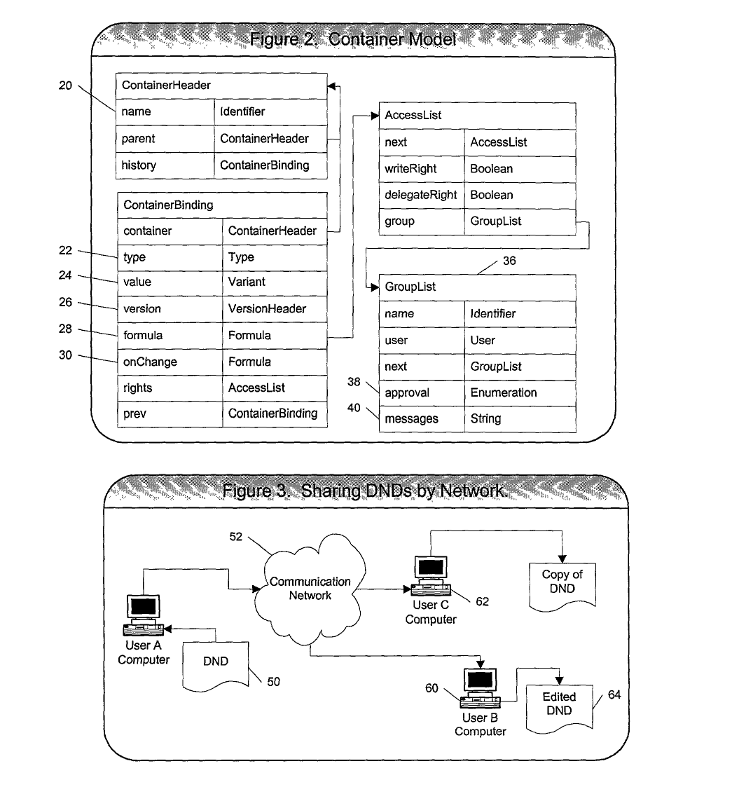

As shown in FIG. 2 each container element has:

a name 20;

a data type 22 such as date, number, text, rich text, a pointer to another data object, or a regular expression consisting of these data elements interleaved with sub-containers;

a current binding 24 to a data value;

a history 26 of version stamped values, with the user who made the update being inferrable from the version;

a formula or script 28 for computing the data value from the values in other containers of the same document or from references to external data sources;

a formula or script 30 that is executed whenever the data value changes;

an indication 34 of whether the container is a locus of access control for itself and its descendant containers;

an access control list 36 identifying named groups of individuals having separate read, write, and delegation permissions;

a list 38 of status indicators identifying, at least, which individuals have approval and rejection authority and whether they have approved or rejected the element; and

a pointer 40 to any discussion messages related to that container element.

A user may view, create, modify, move, and delete individual container elements, subject to permissions belonging to the user. Given read permission, the user is able to view both a container's properties such as its name, data type, and formulae, and to view its contents in the way that they would be rendered in a draft agreement. The user is also able to view changes made to the current version of its contents relative to all previous versions. Given write permission, the user would also be able to directly edit the container properties and its current contents. Given delegation permission, the user would be able to assign other groups and users a subset of the permissions that they have with respect to that container element. Permission to purge previous version values is a separate privilege from permission to edit the contents of the container itself, and a user with sufficient privileges may purge previous versions as well as messages and commentary related to a given container. Users with a particular privilege for a specific container have that privilege for any sub-containers, except for sub-containers that override those privileges with a different set of named privileges.

The data values bound to all container elements in a document can be compressed using standard compression algorithms such as Huffman encoding or LZW compression and individually encrypted using a public key encryption scheme such as the RSA or PGP algorithms. To allow efficient encryption, there may be a distinct private key for each different combination of users and groups appearing in any access control list in the document. Each user has a distinct public-private key pair, and each distinct private key protecting the container elements is encrypted with the user's public key obtained from his publicly registered digital certificate. Therefore, only a user holding the private key paired with his public key will be able to obtain the document's private key allowing him to access the containers to which he has access rights. Whenever it is saved, each version of each changed container is signed with the private key of the user performing the save, using an algorithm such as MD5, to ensure that any subsequent tampering with the document contents can be detected.

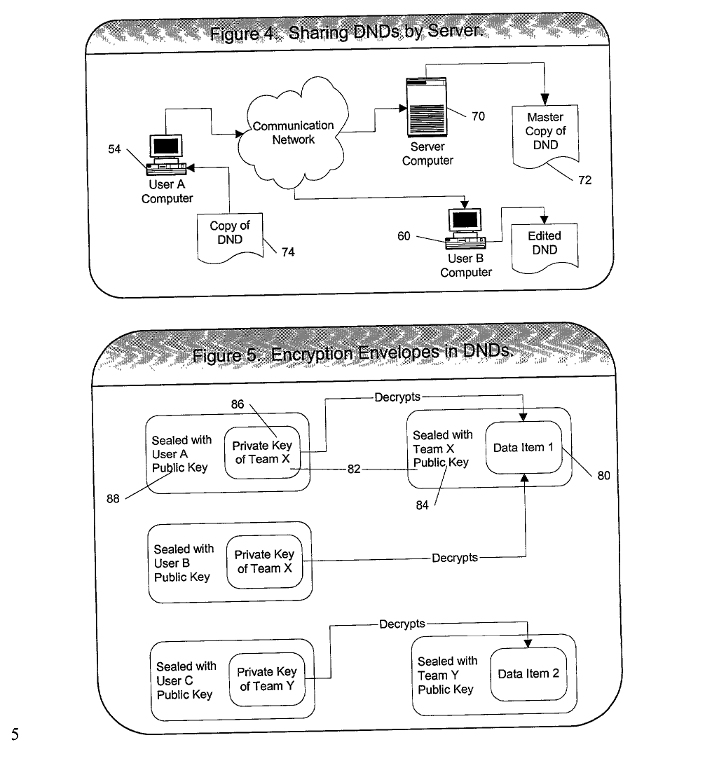

As shown in FIG. 3, DNDs 50 may be shared through a network 52. The user A, for example, uses computer 54 to create and edit a DND and transmit it to other users. The document resides on the computer of the user and is edited there, and it can then be sent to other participants via the communication network.

The DND is a standalone file whose contents can be selectively protected and which contains internal versioning and supports compare and merge operations, so that the user may send electronic copies to other individuals through the communication network (such as the Internet) using any convenient mechanism, such as e-mail or peer-to-peer file sharing. Using their computers, users B 60 and C 62 present the private portions of their public keys in order to gain access to the DND. User B, for example, edits the document and can share the edited document 64 through an electronic delivery mechanism of choice.

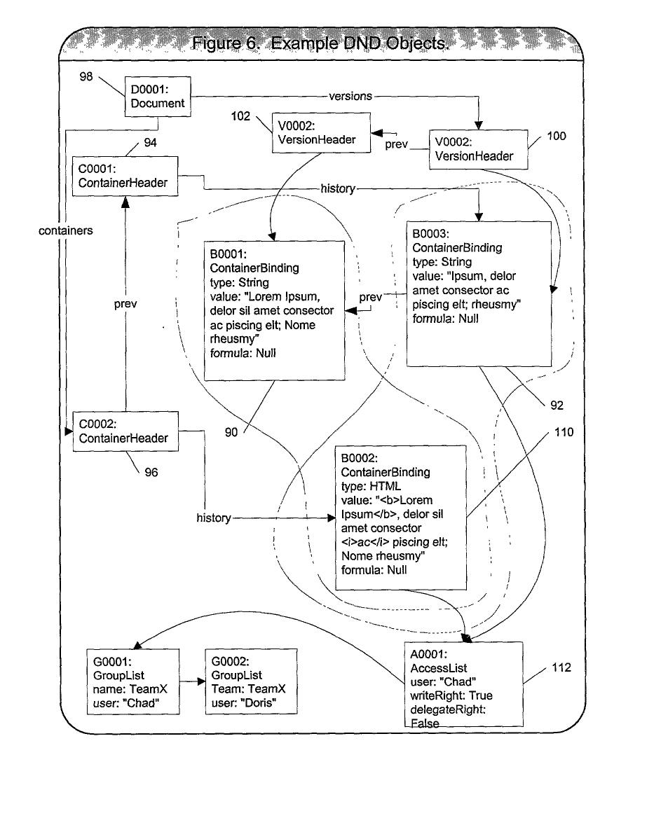

As shown in FIG. 4, a user can create and edit a negotiation document on a shared server 70. Once it is edited in place and saved, other participants are notified of changes by messages. In this case the DND is stored as a single, locked copy 72 supported by the shared server. User A, for example, uses his computer to make changes to a local copy 74 of the DND. The user then updates the master electronic copy 72 through the communication network (such as the Internet) and the server. Using another computer, user B presents the private portions of his public keys to gain access to the DND, obtains exclusive access to the DND, generates an edited document 76, and updates the master electronic copy when finished.

As shown in FIG. 5, data in the DND can be protected from access by unauthorized users. The DND includes separate data items each protected from reading and writing by public-key encryption and an “envelope”. Instead of creating a separate envelope (and therefore, a copy) of each data item for each user who might be allowed access to that data item; a Group mechanism allows each DND to have a locally defined set of group names, so that users can be added and deleted from the group and thereby gain and lose privileges as appropriate. Upon creating a data item 80 of any kind—container, container binding, or other data construct—the software assigns a unique identifier to the set of users (called Team X in the figure) allowed access to that item, assuming that the group does not currently exist.

The software creates a public-private key pair 82 for that group and uses the public key portion 84 to encrypt the data item. The software will grant access to a user to the private key 86 in order to use it for decryption of the data item. This private key is itself encrypted, once using the public key 88 of each user in the group, in this example users A and user B. All other data items encrypted using the private keys of other groups are not accessible in clear-text format to users not a member of the Team X group. This arrangement can be complemented with standard techniques for the management of individual users' private keys and the storage and management of the corresponding public keys in a directory.

An example of a DND object is shown in FIG. 4. The internal organization of a DND instance includes interrelated typed objects. The primary structure of the DND is the set of objects 90, 92 comprising the different versions of a document and the containers in which content is stored. The root of the DND is a Document Header 98 which points to a reverse chronologically ordered set (list) of version headers 102 and containers 94, 96.

Each version includes a header and a list of container bindings 94, 96. Each container binding has a data type and a value and may have a formula. If two successive versions have a container which did not change (i.e., same value, type and formula) then it can be shared 110, otherwise a new container binding 92 is stored and linked to the previous binding of the same container. A specific version then consists of a list of container bindings. New containers can also be added between versions.

Each container binding contains a link to an access list 112 which identifies a specific user. The existence of the record indicates that the user has read permission on that container binding, and Boolean flags indicate whether the user can write the container contents and/or delegate his own permissions on that container binding to other users.

This organization facilitates algorithms for the traversal of individual container bindings within a version, and of the history of values in a container, so as to facilitate complex views in which individual changes are highlighted (“redlined”) along with identification of the user who made that change and in which version. Also, the presence of a root element, the tree structure, and uniquely named objects facilitate efficient operations for compare and merge operations, which both recursively descend through the structure, matching identical nodes and possibly (in the case of a merge) creating a new version in which new container bindings are created to represent the pair-wise merge of container bindings sharing a common ancestor container.

As shown in FIG. 7, classes may be used to organize information within a DND. The class diagram shows the base classes from which the primary objects are derived.

The Document 120 is a class having at least two member variables, one for each of the version and container headers. A Version List 122 represents a single version at the head of the list and a pointer to the headers of earlier versions. Similarly a Container List 126 represents a single container at the head of a list and a pointer to the headers of subsequent containers. A Container Binding 128 is linked by a list of Container Bindings and in turn links to previous bindings of the container as well as to the next Container Binding within a given version. Each Container Binding 128 has an Access List 134 that may be shared among several Container Bindings. The Access List points to a Group 132 that consists of a set of associations between users, their rights with respect to that container, their ability to approve and their current status (Null, Approved, Rejected, or Unknown); and text messages written by that user concerning that particular container binding. Given an apparatus expressed as a class diagram, the serialized form of a DND, for writing and reading by software applications, can be automatically generated in a number of ways, as for example in “Canonical XML form” by translating each Class into an XML Entity and each member variable into an XML Element.

Example container bindings and formulas are shown in FIG. 8. A Container Binding may contain a formula, or, equivalently, a script that computes a value that can be converted into the appropriately typed data value. In this example, the container binding C0015 140 has a formula 142 containing references to other named bindings, including the binding “Seller” 144. References to other containers 145 may be recursively computed and may involve conditional expressions 146 or other computations. Other formula languages may be used, ranging from a simple string-substitution language shown in this example, to regular expression or context-free grammar based languages, or scripting languages such as Visual Basic, JScript or ECMAScript, and different implementations may use different formula syntaxes.

A script can also be associated with a container as the value of the “on Change” member variable, and the script may be executed each time a new container binding is created. This script can be used, for example, to notify members of the legal team on a negotiation that a key clause has been modified. The various container bindings may have different data types 148 and are not restricted to string values. Whenever an application renders the contents of a document for presentation to a user, it evaluates each formula or refers to its cached value.

FIG. 9 illustrates by example the relationship between the different abstraction levels of information storage in a DND. At the most abstract level (as manipulated by the application and called the application data layer) objects have a class such as ContainerBinding 160 and member variables with values. This abstraction is realized in an intermediate layer 162, in which the values of member variables are encrypted and compressed within an envelope 164 and sealed with the private key 166 of the group of users able to access that data, hence layer 162 is called the encrypted envelope layer.

The data can be serialized as XML, represented as the Serial Format layer 168. Additional information at the encryption level includes the mapping of individual users to their own encrypted copy of the team's private key and affixing their signature to the entire document, so that they can access data encrypted for that team, and any tampering can be detected. This mapping of teams, users and keys can also be serialized as XML 168.

Several competencies are considered important to successful negotiation by individuals and organizations are amenable to enhancement by the use of negotiation technology:

Participation. Negotiation technology should make it possible for individuals to have precise and granular ability to view, comment, edit, and approve portions of an overall agreement.

Visibility. It should be possible for supervising managers to easily compare and track the progress of multiple negotiations, based on general factors such as frequency of messages, number of edits, etc., as well as specific features of the negotiation such as effective dates, deadlines, and dollar values.

Options. Negotiation support tools should make it easy to create flexible templates that contain enforceable language covering a variety of different individual options that could appear in a final agreement, even if not all the options are initially revealed to the other party.

Communication. Communication of the state and changes to a negotiation text should be easily manageable by its participants. It should be easy to both share the document among participants and track status, while making it difficult for any individual user to inadvertently breach confidentiality. Related features are that it should not require continuous network connectivity between every participant and a single common server.

Commitments. The agreement itself should contain data and rules that make it able to be processed by other software applications that will extract data needed for, e.g., an order entry or ERP system.

The DND and related elements support each of these negotiation needs in the following ways:

Participation. In the DND, each individual container binding can have a separate access list and groups of users. Each container binding can have a separate user specific object containing granular permissions to read, edit, delegate and approve, as well as the text of any messages or comments added by that user. The encryption envelope wrapped around portions of each container binding ensures that only authorized users are able to view the data.

Visibility. The rich internal structure of the DND allows flexible queries to be written that allow any user with appropriate access rights, particularly supervising managers, to extract specific named container bindings and bindings matching a certain pattern or having a certain data type, and to generate a report either about a specific DND or a set of DNDs having similarities in their internal structure.

Options. Because a container binding value can be computed from a formula, and formulas can refer to other container bindings, it is possible to represent an entire document as nested formulas, so that the values of a few containers (with restricted types, e.g., an enumerated set of options) can drive the selection of larger sections of text. Furthermore, because the containers' contents can be protected from unauthorized parties, by including many interrelated optional elements, a DND can essentially represent an entire space of different documents, and all the options possible at each choice point, without necessarily revealing to the other party what those options are or how they are related.

Communication. The DND encapsulates the state of the negotiation in a single complex data structure which can be serialized and transmitted over any network or shared data system. This allows participants to monitor the state and changes to a negotiation text. The compare and merge operations allow any two DNDs to be compared, but in the case where two DNDs are derived from a common ancestor, the resulting merge produces a new DND containing both merged versions.

Commitments. The DND is a data object that can be fine grained enough to support treatment as a data object by other software applications, because it can contain strongly typed, labeled data that can be preserved from version to version, access controls to prevent the deletion of the container (although the binding may be changed) and formulas that ensure consistency between the values assigned to different container bindings.

Additional information concerning a negotiation system in which DNDs could be provided and used is contained in U.S. patent application Ser. No. 09/489,197, filed Jan. 20, 2000, and incorporated by reference.

1. A method comprising
enabling a party to a negotiation to create a document containing text, typed data, and formulas configured to generate optional texts,
enabling a party to the negotiation to manipulate the document as a hierarchically structured set of containers, and permitting a party to view protected portions of the document only upon presentation of a cipher key associated with those portions.

2. A method comprising
enabling a party to a negotiation to create a document containing text, typed data, and formulas configured to generate optional texts,
enabling a party to the negotiation to manipulate the document as a hierarchically structured set of containers, and
maintaining a version history of portions of the document sufficient to enable a user to view and display changes between successive versions of the document.

3. A method comprising
enabling a party to a negotiation to create a document containing text, typed data, and formulas configured to generate optional texts,
enabling a party to the negotiation to add annotations to the document, and
maintaining a version history of portions of the document sufficient to enable a user to view and display changes between successive versions of the document.

4. A method comprising
enabling a party to a negotiation to create a document containing text, typed data, and formulas configured to generate optional texts,
enabling a party to the negotiation to manipulate the document as a hierarchically structured set of containers,
permitting a party to view protected portions of the document only upon presentation of a cipher key associated with those portions, and
maintaining a version history of portions of the document sufficient to enable a user to view and display changes between successive versions of the document.

5. A method comprising
enabling a party to the negotiation to create a document containing text, typed data, and formulas configured to generate optional texts,
enabling a party to the negotiation to manipulate the document as a hierarchically structured set of containers,
enabling a party to a negotiation to add annotations to the document,
permitting a party to view protected portions of the document only upon presentation of a cipher key associated with those portions, and maintaining a version history of portions of the document sufficient to enable a user to view and display changes between successive versions of the document.

6. The method of claim 1, 2, 3, 4, or 5, also including
transmitting a state and history of the negotiation from user to user using a network communication protocol.

7. The method of claim 6 in which the protocol includes e-mail, client-server file transfer, or peer-to-peer file transfer.

8. Apparatus comprising a medium on which are stored
data structures capable of configuring a machine to enable a negotiation of a document, the data structures comprising
linked discrete elements, each of the linked elements having value binding and formula features,
each of the elements being linked into a hierarchical structure,
each of the linked elements having annotation features,
the data structures being expressed in a serialized data format that represents content of the linked discrete elements encrypted separately for each group of users able to access parts of the document,
the content of linked discrete elements being associated with a version history capable of configuring a machine to render complete document versions, and
software capable of configuring the machine to enable a user to create the document, edit the document by adding new versions, attach messages, add, remove and change the access rights of users with respect to individual document elements, compare and merge documents, and purge version histories.
